(19) United States
(12) Patent Application Publication
(10) Pub. No.: US 2025/0102021 A1
(43) Pub. Date: Mar. 27, 2025

(54) CLUTCH

(71) Applicant: Elaborazioni Elettroniche Di Sparacia Franco, Castelvetrano (TP) (IT)

(72) Inventors: Franco SPARACIA, Castelvetrano (IT); Gioele Pietro SPARACIA, Castelvetrano (IT)

(21) Appl. No.: 18/894,530

(22) Filed: Sep. 24, 2024

(30) Foreign Application Priority Data
Sep. 26, 2023 (IT) 102023000019767

(51) Int. Cl. F16D 25/08

(52) U.S. Cl. CPC F16D 25/083

(57) ABSTRACT

A clutch (1) is provided, connected to a gear shaft (20) and a driving shaft (30) within a motor vehicle, the clutch (1) comprising: a circular clutch disc (2) integral with the gear shaft (20); a flywheel (3) integral with the driving shaft (30); the driving shaft (30) and the gear shaft (20) being aligned and defining a common main axis (1a); a support (31) integrally connected with the flywheel (3) and together defining a cavity (10) configured to house the clutch disc (2); the clutch disc (2) and the cavity (10) having the main axis (1a) as their central axis; a coaxial shaft (32) hollow and integrally connected to the support (31) configured to house the gear shaft (20) and coaxial to the main axis (1a); an actuator (5) configured to bring the clutch disc (2) into contact with the flywheel (3); a trigger (4) operatively connected to the actuator (5), operable by a driver, and configured to control the actuator (5); a stator (6) comprising a through-hole (60) configured to allow the passage of fluid and to connect the trigger (4) with the coaxial shaft (32); the actuator (5) comprising at least one piston (50) positioned in-between the support (31) and the circular clutch disc (2), housed in the cavity (10) and configured to move parallel to the main axis (1a); a duct (33) for the passage of fluid, located in the support (31) and in the coaxial shaft (32) having at least one first opening (33a) at the outer surface of the coaxial shaft (32) and at least one second opening (33b) at the cavity (10); the support (31) and the piston (50) defining in the cavity (10) a cylindrical internal chamber (52) configured to contain fluid under pressure and to ensure that it does not outflow.

The present invention relates to a clutch of the type specified in the preamble of the first claim.

The object of the present invention is a clutch having application in mechanics, in the automotive field, and, in particular, for heavy-duty and agricultural vehicles. Currently, clutches for vehicles are known, which ensure that the rotation of the engine shaft, imparted by the engine, can be transmitted to the gear shaft, in order to, in turn, transmit the motion to vehicle wheels.

Therefore, the clutch plays the role of transmitting the motion from the engine shaft to the gear shaft.

The most general scheme of this type of mechanism consists of a flywheel integral with the driving shaft and located at the end of the shaft itself. The flywheel is the component that performs the function of coming into contact with the clutch itself so as to transmit the rotation of the flywheel to the gear shaft.

Consequently, the clutch disc is positioned opposite the flywheel. The clutch disc is positioned at the end of the gear shaft and is integral in rotation with it but slides a few millimeters axially along the splined shaft.

In many embodiments, the flywheel is integral with a component coaxial to the flywheel and the clutch disc itself, called the pressure plate. The pressure plate consists of a partially disc-shaped component, containing a spring or a spring system. In the most common solutions, the spring in the pressure plate is a diaphragm spring, having an axis coincident with the axes of the two shafts. The diaphragm spring performs the function of pushing the clutch disc against the flywheel when the clutch pedal is released. Specifically, when the driver presses the clutch pedal, a bearing coaxial to the gear shaft is actuated; the piston presses the central portion of the diaphragm spring, which pushes the central portion toward the flywheel and, at the same time, the outer portion in the opposite direction. The outer portion of the pressure plate is in contact with the clutch disc; therefore, when this portion is pressed, the clutch disc is disengaged from the flywheel.

The described known art has some significant drawbacks. In the known solutions, the engagement and disengagement of the clutch disc are mediated by the pressure of the bearing acting on the diaphragm spring. In particular, in situations of high loads and/or accelerating driving torques, the spring blades can no longer guarantee adequate pressure on the clutch disc, which tends to slip, resulting in overheating and wear of the disc itself. Consequently, fine dust is produced, harmful to health and in conflict with the upcoming Euro 7 regulations of 2025.

Another disadvantage of the known mechanism is the greater complexity of the mechanism, consisting of several components that intermediate the action of the central bearing push on the diaphragm spring. Therefore, the actuation depends on a sequence of operations. Furthermore, the presence of more components increases the risk of failures.

To remedy these drawbacks, some fluid dynamic clutches have been devised that operate through pistons and the like present inside the clutch. Similar clutches are described in patent applications: JP-A-H05164143; EP-A-4062081; US-A-2002/000356; FR-A-2549177; JP-A-S61130627; CN-A-103317756 and CN-A-103206585.

However, these clutches have the problem of transferring fluid from the fixed portion to the rotating portion. This transfer is very problematic and complex to achieve.

In this situation, the technical task behind the present invention is to devise a clutch capable of substantially overcoming at least part of the aforementioned drawbacks. Within the scope of this technical task, an important objective of the invention is to achieve a clutch that improves the control of the flywheel-clutch coupling, making it extremely integral.

Another important objective of the invention is to make the use of the clutch and driving conditions more comfortable.

Another important objective of the invention is to design a clutch with a reduced complexity of the actuation mechanism.

The technical task and the specified objectives are achieved by a clutch as claimed in the appended claim 1.

Preferred technical solutions are highlighted in the dependent claims.

The features and advantages of the invention are clarified below by the detailed description of preferred embodiments of the invention, with reference to the attached drawings, wherein:

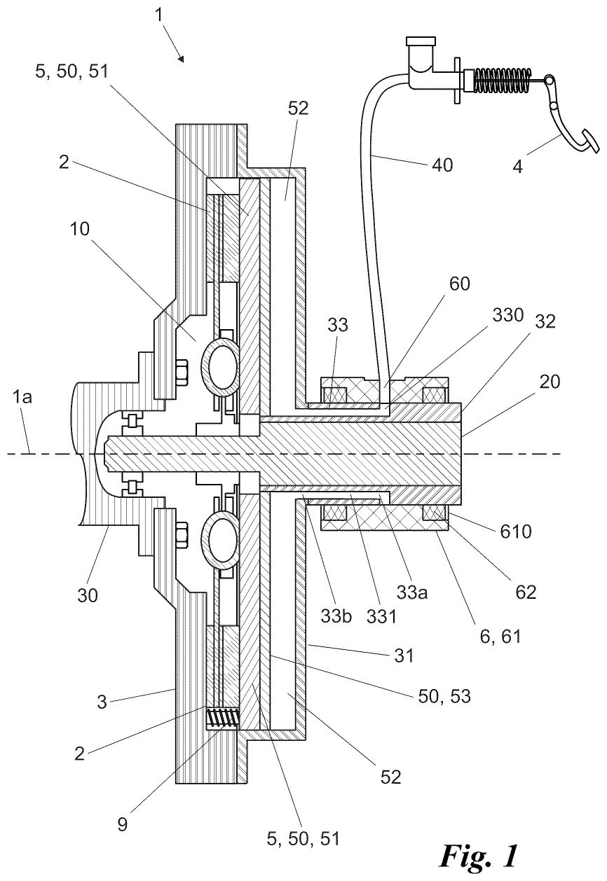

FIG. 1 shows a longitudinal section of a clutch according to the invention;

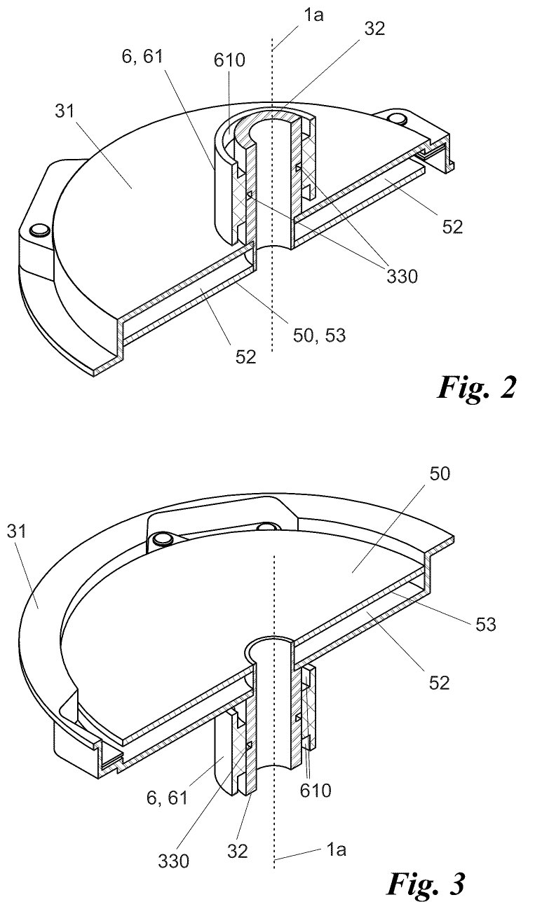

FIG. 2 illustrates a first view of a first portion of a clutch according to the invention;

FIG. 3 illustrates a second view of a first portion of a clutch according to the invention;

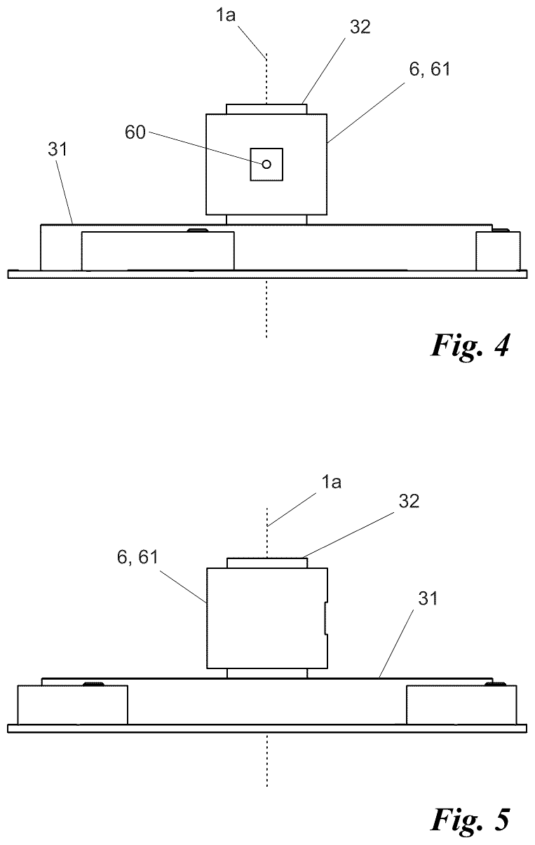

FIG. 4 shows a first side view of a portion of a clutch according to the invention;

FIG. 5 shows a second side view of a portion of a clutch according to the invention;

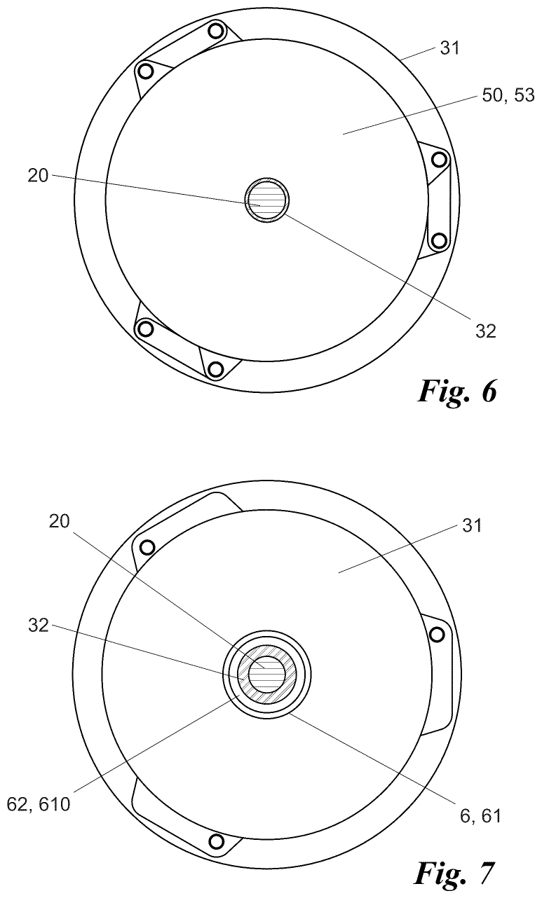

FIG. 6 shows a top view of a portion of a clutch according to the invention; and

FIG. 7 shows a bottom view of a portion of a clutch according to the invention.

In this document, the measurements, values, shapes, and geometric references (such as perpendicularity and parallelism), when associated with words like “about” or other similar terms such as “approximately” or “substantially”, are to be understood as subject to measurement errors or inaccuracies due to production and/or manufacturing errors and, especially, subject to a slight deviation from the value, measurement, shape, or geometric reference to which they are associated. For example, such terms, when associated with a value, preferably indicate a deviation not exceeding 10% of the value itself.

Furthermore, when used, terms like “first”, “second”, “upper”, “lower”, “main”, and “secondary” do not necessarily identify an order, a priority of relationship, or relative position but may simply be used to more clearly distinguish between different components.

Unless otherwise specified, as evident from the following discussions, terms such as “processing”, “computing”, “determination”, “computation”, or similar, refer to the action and/or processes of a computer or similar electronic computing device that manipulates and/or transforms data represented as physical quantities such as electric quantities of records of a computer system registers and/or memories into other data similarly represented as physical quantities within computer systems, records, or other information storage, transmission, or display devices. The measurements and data reported in this text are to be considered, unless otherwise indicated, as performed in the International Standard Atmosphere ICAO (ISO 2533:1975).

With reference to the Figures, the clutch according to the invention is globally denoted by number 1.

The clutch 1 is a mechanical component configured to transmit to the wheels of a motor vehicle the rotational motion generated by the engine.

The clutch 1 is connected to a gear shaft 20 and a driving shaft 30. The gear shaft 20 is the shaft configured to transmit the rotational motion from the driving shaft 30 to the vehicle gearbox. From the gearbox, the rotation is then transmitted to vehicle wheels.

The driving shaft 30 is the shaft directly rotated by the vehicle engine.

The driving shaft 30 and the gear shaft 20 are aligned and define a common main axis 1a. The main axis 1a is, therefore, the common axis of rotation of both shafts. The clutch 1 comprises a clutch disc 2. This is the component that implements the interaction between the driving shaft 30 and the gear shaft 20.

In particular, the clutch disc 2 is circular and integral with the gear shaft 20. Specifically, the clutch disc 2 is adapted to rotate around the main axis 1a. The main axis 1a preferably passes through the center of the clutch disc 2.

The clutch 1 also comprises a flywheel 3. This is a component preferably disc-shaped and circular. Specifically, it is preferably a disc comprising a raised edge, protruding parallel to the main axis 1a, and the surface of the inner portion is intended to come into contact with the clutch disc 2. The flywheel 3 also rotates around its center lying on the main axis 1a. The flywheel 3 is integral with the driving shaft 30. Therefore, it rotates at the speed at which the driving shaft 30 rotates, corresponding to the speed imparted by the engine cylinders.

The clutch 1 also includes a support 31. This is integrally bound to the flywheel 3. Therefore, the support 31 also rotates with the driving shaft 30. The support 31, similarly to the flywheel 3, includes a disc-shaped portion with an edge protruding in a direction parallel to the main axis 1a. Thus, the support 31 has a shape similar to the flywheel 3 and is oriented in the opposite direction to the flywheel. In this regard, the protruding edge of the support 31 faces the protruding edge of the flywheel 3 and is preferably integrally bound to the protruding edge of the flywheel 3. Therefore, the support 31, together with the flywheel 3, defines a cavity 10. This cavity is formed by the space in between the flywheel 3 and the support 31 and is delimited by the mutually bound protruding edges and the inner surfaces of the support 31 and the flywheel 3. The cavity 10 is configured to house the clutch disc 2. The cavity 10 preferably has, at least in the area corresponding to the support 31, a cylindrical shape with an axis coinciding with the main axis 1a. Additionally, the cavity 10, at least at the support 31, preferably has a diameter similar to the diameter of the clutch disc 2, as specified below. Inside the cavity 10, the clutch disc 2 can therefore slide along the main axis 1a and rotate around the main axis 1a.

The clutch 1 includes a coaxial shaft 32. This is a hollow shaft integral with the support 31 and is designed to house the gear shaft 20. Therefore, the internal hollow portion is designed to accommodate the gear shaft 20. The coaxial shaft 32, being integral with the support 31 and thus with the flywheel 3, rotates integrally with the driving shaft 30. In one embodiment of the clutch 1, the support 31 is one single piece with the coaxial shaft 32. The coaxial shaft 32 is coaxial with the main axis 1a, which, as described earlier, corresponds to the axis of the gear shaft 20. The coaxial shaft 32 preferably has a smaller diameter than the diameter of the cavity 10, as better specified below. The gear shaft 20, in any case, only rotates when the rotational motion is transmitted to the clutch disc 2.

In this regard, the clutch 1 includes an actuator 5. This is a mechanical component configured, at the very least, to bring the clutch disc 2 into contact with the flywheel 3.

The actuator 5 advantageously includes at least one piston 50. Specifically, the piston 50 is positioned in between the support 31 and the clutch disc 2. The piston 50 is preferably circular, housed in the cavity 10, and is arranged to move within the cavity 10 parallel to the main axis 1a. The clutch 1 has the advantage of bringing the clutch disc 2 into contact with the flywheel 3 by the action of the piston 50. In this way, the clutch 1 provides more suitable driving conditions during acceleration or towing, as it prevents the clutch disc 2 from slipping, given that the pressure load of the piston 50 is twice that of the spring-loaded system. In fact, for high driving torques of driving shaft 30, a high load force is required to prevent the clutch disc 2 from slipping on the flywheel 3.

Consequently, in the traditional system, a greater force would also be required to disengage the clutch disc 2 from the flywheel 3, which would affect the driver's comfort.

This effect results in the clutch being less user-friendly at high torsion speeds during acceleration in known types of clutches. The clutch 1 is therefore advantageously comfortable when the driving shaft 30 rotates at high driving torques, always due to the significant pressure that a hydraulic piston provides compared to the common flat springs.

Preferably, the clutch 1 includes only one piston 50.

The piston 50 uses a fluid to be actuated. Specifically, the fluid preferably includes clutch oil. Mineral oil can be particularly used. Mineral oil used for clutches has the advantage of protecting the mechanical components against corrosion and having a viscosity that allows it to flow quickly with little variability with temperature.

Piston 50 is preferably a single-acting piston. The single-acting piston is advantageous because the fluid passage channeling is simplified, as it has only one channel for both the input and removal of the fluid.

Thus, piston 50 preferably includes a chamber wherein the fluid is introduced and a movable wall integrally connected to the portion intended to come into contact with the clutch disc 2.

In addition, piston 50, together with support 31, defines, within the cavity 10, and preferably within the cavity 10 defined by said support 31, an internal chamber 52. The internal chamber 52 is the space of the piston 50 designed to contain the fluid. The internal chamber 52 is preferably cylindrical. It also preferably has a base of said cylinder entirely constituted by the piston 50.

Dimensionally, the diameter of the internal chamber 52 preferably coincides with or is similar to, or does not vary by more than 10% from, the diameter of the cavity 10. Moreover, the internal chamber 52 preferably has a diameter similar to the diameter of the clutch disc 2 and more preferably varies from the latter by a percentage of less than 30%, more preferably less than 20%, and even more preferably less than 10%. Furthermore, the diameter of the cavity 10 is preferably larger than the diameter of the clutch 2.

Furthermore again, the coaxial shaft 32 preferably has a diameter less than 50% of the diameter of the internal chamber 52 (it is therefore half the diameter of the internal chamber 52), more preferably less than 30%, and even more preferably less than 20%.

Additionally, again the diameter of the internal chamber 52 is preferably between 1 dm and 4 dm, more preferably from 1 dm to 3 dm.

In particular, piston 51 may include a movable element 51. The movable element 51 may include a wall 53. The latter is the flat end of the movable element 51 intended to serve as a movable wall, located within the internal chamber 52, and a movable stem integral with the movable wall, directed outward from the internal chamber 52, and moved by the internal pressure of the fluid against the wall 53. The wall 53 may be flat and oriented orthogonally to the main axis 1a. In some embodiments of the clutch 1, the wall 53 is parallel to the opposite wall of the internal chamber 52, which is also flat, perpendicular to the main axis 1a, and corresponds to the inner surface of support 31.

Therefore, the movable element 51 is preferably arranged to be moved toward the clutch disc 2. Specifically, when the fluid is introduced into the internal chamber 52, the movable wall is pushed so as to move the entire movable element 51 away from support 31 and toward clutch disc 2.

Once contact is made between the movable element 51 and the clutch disc 2, the movable element 51 moves the clutch disc 2 by contact. The further movement of the movable element 51 pushes the clutch disc 2 so as to bring the clutch disc 2 into contact with the flywheel 3. The movement of the movable element 51 occurs when fluid is introduced into piston 50.

When clutch disc 2 is in contact with flywheel 3, to maintain contact and thus the transmission of motion from flywheel 3 to clutch disc 2, it is necessary to keep clutch disc 2 pressed against flywheel 3. Therefore, to maintain the contact and transmission of motion from the engine shaft 30 to the gear shaft 20, the same fluid level is maintained within piston 50. In this way, the same pressure level exerted by the fluid on the movable element 51 is maintained.

In clutch 1, piston 50 preferably has the shape of a cylinder coaxial with the main axis 1a. Additionally, it is hollow at the main axis 1a and at the gear shaft 20.

Specifically, piston 50 may include an internal anular chamber 52 defining a coaxial opening 54. The latter is a through opening with its center at the main axis 1a. The gear shaft 20 is nested inside the coaxial opening 54, meshing with the clutch disc 2 at the end inside the cavity 10. The movable element 51 may also have an annular shape. Specifically, the wall 53 may be disc-shaped and hollow at the coaxial opening 54, so as to fit the internal chamber 52 and ensure that the fluid contained within the internal chamber 52 does not outflow, for example, by the presence of o-rings or other sealing rings to prevent fluid leakage. In this regard, the edges of the wall 53 may include seals to confine the fluid within the internal chamber 52.

The end outside the internal chamber 52, of the movable element 51 may have a flat contact surface parallel to the surface of the clutch disc 2, so that when contact is made, the mutual contact surface is maximized.

The clutch 1 comprises a trigger 4. The latter is operatively connected to the actuator 5. Furthermore, the trigger 4 can be operated by a driver and is configured to control the actuator 5. Specifically, the trigger 4 is the component that controls the actuation of piston 50. Actuation occurs by sending fluid into the piston 50.

In this regard, clutch 1 advantageously includes a duct 33. The duct 33 allows the passage of fluid. Specifically, the duct 33 performs the function of ensuring that the fluid is introduced into the internal chamber 52. The duct 33 is preferably located in the support 31 and in the coaxial shaft 32.

In detail, duct 33 has at least a first opening 33a. The latter is preferably positioned at the outer surface of the coaxial shaft 32. Additionally, duct 33 has at least a second opening 33b at the piston 50.

Each second opening 33b is preferably located at the end of duct 33 in fluid communication with the internal chamber 52.

The duct 33 preferably includes a radial injection channel 330. The latter preferably consists of a groove perpendicular to the main axis 1a on the outer surface of the coaxial shaft 32. The radial injection channel 330 may be a groove forming a ring on the outer surface of the coaxial shaft 32. The radial injection channel 330 performs the function of receiving the fluid and sending it toward the piston 50, or of passing the fluid in the opposite direction when the fluid is removed from the internal chamber 52. This geometry is advantageous as it facilitates the fluid passage from a static component to the rotating coaxial shaft 32, which is integrally connected to the flywheel 3.

The duct 33 preferably includes at least an axial injection channel 331. This is preferably connected to the radial injection channel 330. In detail, the axial injection channel 331 is connected to the radial injection channel 330 by each first opening 33a. Therefore, each opening 33a puts the radial injection channel 330 in communication with the coaxial shaft 32. As a result, each axial injection channel 331 is preferably located in the coaxial shaft 32.

Additionally, each axial injection channel 331 is preferably connected to at least one piston 50 by at least one second opening 33b. In this way, fluid is introduced into each piston 50.

In one embodiment of the clutch 1, the axial injection channel 331 may be oriented parallel to the main axis 1a. This simplifies the geometry of the axial injection channel 331 and minimizes the length of the path the fluid must travel to reach piston 50.

In clutch 1, there may be two axial injection channels 331, which are parallel and diametrically opposed with respect to the coaxial shaft 32. Each of the two axial injection channels 331 communicates with the radial injection channel 330 through two respective first openings 33a located on the wall of the groove oriented perpendicular to the main axis 1a. In this embodiment, each of the two axial injection channels 331 may have a cylindrical development with an axis parallel to the main axis 1a. Each second opening 33b connects each respective axial injection channel 331 to the internal chamber 52 of the single piston 50, which has a hollow cylindrical shape.

Clutch 1 includes a stator 6. The latter is a fixed component relative to the movement of the coaxial shaft 32. It serves the function of allowing the fluid to be introduced into the duct in such a way that the fluid can pass from a static component to a moving component, as in this case, the coaxial shaft 32.

Therefore, the stator 6 is in contact with the outer surface of the coaxial shaft 32. Furthermore, the stator 6 includes a through-hole 60. The through-hole puts two opposite surfaces of the stator 6 in communication. It is designed to allow the fluid to pass and to connect the trigger 4 with the coaxial shaft 32.

In this regard, the radial injection channel 330 is preferably covered by the stator 6.

In fact, it is positioned at the groove so that the through-hole 60 aligns with the groove. In detail, the radial injection channel 330 is thus delimited by the walls of the groove and the stator 6. The through-hole 60 is positioned at the radial injection channel 330 so that the fluid is introduced through the through-hole 60 into the radial injection channel 330.

The stator 6 preferably includes a coaxial ring 61 with the coaxial shaft 32. The coaxial ring 61 is a ring-sized to house the coaxial shaft 32. The ring shape and the position of the through-hole 60 facilitate the coupling of the stator 6 with the coaxial shaft 32, ensuring that the fluid can be transferred from the fixed stator 6 to the rotating coaxial shaft 32. Specifically, the rotational motion of the coaxial shaft 32 ensures that the fluid from the through-hole 60 can be collected in the groove to avoid leakage.

In this regard, the coaxial ring 61 preferably includes at least one oil seal housing 610. Each oil seal housing 610 comprises an annular-shaped cavity coaxial with the coaxial shaft 32. Each annular-shaped cavity communicates with the outside. The coaxial ring 61 preferably includes at least one oil seal 62. The oil seal 62 may be a gasket and serves the function of preventing the fluid from passing through the cavity wherein it is housed. Specifically, each oil seal 62 is housed in its respective oil seal housing 610.

In one embodiment of the clutch 1, the coaxial ring 61 includes two oil seal housings 610 positioned at the ends of the coaxial ring 61, and inside the two oil seal housings 610 the respective oil seals 62 are housed.

As previously mentioned, the actuation of the clutch 1 depends on the trigger 4. In detail, the trigger 4 preferably includes an external duct 40. It may be a duct suitable for the passage of fluid and, specifically, for the passage of oil. The external duct 40 is preferably connected to stator 6 via the through-hole 60. The external duct 40 is, therefore, the duct designed to introduce the fluid into the duct 33 or to suck out the fluid from the duct 33.

Thus, the trigger 4 is preferably configured to suck the fluid from the piston 50 when actuated and to introduce the fluid into the piston 50 when not actuated. In detail, the trigger 4 includes a pump configured to control the passage of fluid in the external duct 40. Therefore, the external duct 40 is connected to a pump. The operation of the pump is controlled by the clutch pedal, which can be operated by a driver. Specifically, pressing the clutch pedal controls the suction of the fluid from the piston 50. When the clutch pedal is not pressed, the fluid remains inside the internal chamber 52, and the clutch disc 2 remains in contact with the flywheel 3. In particular, the pump may include a load spring. The latter can provide a boost generating a pressure that can reach a value of 10 bars.

The clutch may preferably include a return element 9, such as at least one pin, preferably 3 pins, screwed into the piston disc to make it integral with the flywheel 3. The pins preferably enter and slide into three holes made in the flywheel. Coaxially with the pins, there are preferably springs to facilitate the faster return of piston 50. Preferably, the clutch disc will have a diameter that does not interfere with the pins.

The operation of the clutch 1 previously described in structural terms is as follows.

When the clutch pedal is released, the pump controlling the oil passage introduces oil into the duct 40, wherein the load spring is found. The oil passes through the stator 6 via the through-hole 60. From the through-hole 60, oil is introduced into the radial injection channel 330. From the radial injection channel 330, rotating at the driving shaft 30 speed, oil passes through the first opening 33a and enters the axial injection channel 331. The fluid, once it has travelled through the axial injection channel 331, enters the internal chamber 52 of the piston 50 through the second opening 33b. When the oil pressure inside the internal chamber 52 increases, the wall 53 is moved toward the clutch disc 2 with a translational movement along the main axis 1a. As a result, the entire movable element 51 of piston 50 is moved toward the clutch disc 2. The movable element 51 and the clutch disc 2 come into contact. To achieve a further increase in pressure, the movable element 51 and the clutch disc 2 while in contact, are moved toward the flywheel 3. The translational movement of the clutch disc 2 and the movable element 51 ends when the clutch disc 2 contacts the flywheel 3 and is pressed against the flywheel 3. Once the clutch disc 2 is pressed against the flywheel 3, the clutch disc rotates at the same speed as the flywheel. Therefore, the clutch disc 2 rotates at the same speed of the driving shaft 30, and consequently, the gear shaft 20 rotates at the same speed of the driving shaft 30.

The contact between the clutch disc 2 and the flywheel 3 lasts until the clutch pedal is not pressed, and the fluid is kept under pressure within the piston 50.

When the clutch pedal is pressed, the pump reduces the oil pressure inside the internal chamber 52 proportionally to pedal pressure. The reduction in oil pressure reduces the pressure on the movable element 51, and consequently, the pressure of the movable element on the clutch disc 2, consequently the pressure of the clutch disc 2 on the flywheel 3 is reduced. Therefore, the clutch disc 2 moves away from the flywheel 3, and the gear shaft 20 reduces its rotational speed, as it is no longer coupled to the driving shaft 30. The disengagement of the clutch disc 2 from the flywheel 3 becomes more effective the lesser the oil pressure is inside the internal chamber 52. Maximum disengagement is achieved with full depression of the clutch pedal. Conversely, the maximum force of the piston 50 occurs with the clutch pedal released.

The clutch 1 according to the invention achieves important advantages.

Indeed, the clutch 1 has the advantage of being able to withstand greater driving torques during acceleration, as the cylinder's thrust load is twice that of the traditional system. Specifically, the clutch 1 can be used for both racing cars and road cars with high driving torques, whether they are diesel or petrol engines. Additionally, the clutch 1 improves the driver's control over the clutch. Indeed, the clutch 1 ensures that the actuation mechanism operates through the direct pressure of a piston against the clutch disc 2, without the mediation of a diaphragm spring.

Consequently, the clutch 1 has the advantage of a less complex mechanism. This advantage reduces the number of components needed, resulting in lower production and assembly costs.

Furthermore, given the large area of the internal chamber 52 within which the pressurized fluid acts, only a reduced fluid pressure is needed to apply significant force on the clutch. The reduced pressure results in a simpler fluid connection at the interaction between the stator 6 and the shaft 32.

The invention is susceptible to variations within the scope of the inventive concept defined by the claims.

Within this scope, all details are replaceable by equivalent elements, and the materials, shapes, and dimensions can be any.

1. A clutch (1) connected to a gear shaft (20) and a driving shaft (30) within a motor vehicle, said clutch (1) comprising:
a circular clutch disc (2) integral with said gear shaft (20);
a flywheel (3) integral with said driving shaft (30);
said driving shaft (30) and said gear shaft (20) being aligned and defining a common main axis (1a);
a support (31) integrally bound to said flywheel (3), said support (31) and said flywheel (3) together defining a cavity (10) configured to house said clutch disc (2);
said clutch disc (2) and said cavity (10) having said main axis (1a) as their central axis;
a hollow coaxial shaft (32) integral with said support (31), configured to house said gear shaft (20) and coaxial to said main axis (1a);
an actuator (5) configured to bring said clutch disc (2) at least into contact with said flywheel (3);
a trigger (4) operatively connected to said actuator (5), operable by a driver, and configured to control said actuator (5);
a stator (6) in contact with the external surface of said coaxial shaft (32), and comprising a through-hole (60) configured to allow the passage of fluid and to connect said trigger (4) with said coaxial shaft (32); and characterized in that it further comprises:
said actuator (5) comprising at least one piston (50) positioned in-between said support (31) and said circular clutch disc (2), housed inside said cavity (10), and configured to move within said cavity (10) parallel to said main axis (1a);
a duct (33) for the passage of said fluid, located in said support (31) and in said coaxial shaft (32), having at least one first opening (33a) at the external surface of said coaxial shaft (32) and at least one second opening (33b) at said cavity (10);
said support (31) and said piston (50) defining, inside said cavity (10), a cylindrical internal chamber (52) configured to contain said fluid under pressure and to ensure that said fluid contained inside said internal chamber (52) does not escape.

2. The clutch (1) according to claim 1, wherein said stator (6) comprises a coaxial ring (61) with said coaxial shaft (32).

3. The clutch (1) according to claim 2, wherein said coaxial ring (61) comprises at least one oil seal housing (610) and at least one oil seal (62) inside said oil seal housing (610).

4. The clutch (1) according to claim 2, wherein said duct (33) comprises a radial injection channel (330) formed by a groove perpendicular to said main axis (1a) on the external surface of said coaxial shaft (32) and covered by said stator (6) positioned at said groove in such a way that said through-hole (60) aligns with said groove.

5. The clutch (1) according to claim 1, wherein said fluid comprises clutch oil.

6. The clutch (1) according to claim 1, wherein said piston (50) is a single-acting piston.

7. The clutch (1) according to claim 1, wherein said piston (50) is shaped as a cylinder coaxial with said main axis (1a) and hollow at said main axis (1a) and said gear shaft (20).

8. The clutch (1) according to claim 1, wherein said piston (50) is integral with said support (31) and comprises a movable element (51) configured to be moved toward said clutch disc (2) and to move said clutch disc (2) by contact, in such a way as to bring said clutch disc (2) into contact with said flywheel (3) when said fluid is introduced into said piston (50).

9. The clutch (1) according to claim 4, wherein said duct (33) comprises at least one axial injection channel (331) connected to said radial injection channel (330) via each said first opening (33a), each said axial injection channel (331) being located in said coaxial shaft (32), each said axial injection channel (331) communicating with said at least one piston (50) via at least one said second opening (33b) so as to introduce said fluid into said at least one piston (50).

10. The clutch (1) according to claim 1, wherein said trigger (4) comprises an external duct (40) connected to said stator (6) via said through-hole (60), said trigger (4) being configured to draw said fluid from said piston (50) when actuated and to introduce said fluid into said piston (50) when not actuated.

11. The clutch (1) according to claim 1, wherein said internal chamber (52) has a diameter that varies by less than 30% compared to the diameter of said clutch disc (2).

12. The clutch (1) according to claim 1, wherein said coaxial shaft (32) has a diameter less than 50% of the diameter of said internal chamber (52).

13. The clutch (1) according to claim 1, wherein said internal chamber (52) has a diameter between 1 dm to 3 dm.
